(19) United States
(12) Patent Application Publication
(10) Pub. No.: US 2025/0097842 A1
(43) Pub. Date: Mar. 20, 2025

(54) METHOD OF COMMUNICATION BETWEEN TWO DEVICES AND DEVICES FOR IMPLEMENTING THE METHOD

(71) Applicant: ACTILITY, Lannion (FR)

(72) Inventor: Olivier Hersent, Louveciennes (FR)

(21) Appl. No.: 18/884,704

(22) Filed: Sep. 13, 2024

(30) Foreign Application Priority Data
Sep. 15, 2023 (FR) 2309778

(51) Int. Cl. H04W 52/02; H04W 72/21; H04W 88/04

(52) U.S. Cl. CPC H04W 52/0229; H04W 72/21; H04W 88/04

(57) ABSTRACT

A method of communication between a first device and a second device is proposed, the first device being a low-power wireless end-device of an LP-WAN type data communication network, and the second device being a low-power wireless device that is not a node of the LP-WAN type data communication network, the first device being configured to behave as a relay node with respect to the second device. The method is implemented by the first device, and comprises: receiving a wake-up message from the second device, via an application layer of the first device; transmitting, to the second device, a message to acknowledge receipt of the wake-up message and to synchronize with the second device; receiving a data packet from the second device and transmitting the data packet on to the LP-WAN type data communication network, the data packet being inserted in an uplink data transmission message in a communication protocol of the LP-WAN type data communication network.

### CROSS-REFERENCE TO RELATED APPLICATIONS

This application claims priority benefit under 35 U.S.C. § 119 (d) from French Patent Application No. 2309778, filed Sep. 15, 2023, the disclosure of which is incorporated by reference herein in its entirety.

### BACKGROUND

### Technical Field

The present disclosure relates to a method of communication between two devices and to a device for implementing this method. It applies in particular to communication between devices, including a low-power wireless end-device of an LP-WAN type data communication network.

### Description of the Related Art

The development of communication techniques between two devices in the context of the Internet of Things (IoT) has led to the emergence of low-power wide area network (LP-WAN) data communication networks such as the LoRaWAN network. LP-WAN network technologies, which comprise communication protocols between nodes of an LP-WAN network, are, among other things, an answer to the energy management needs of end-devices (or nodes) which are connected objects generally operating on batteries. Due to this energy management constraint on end-devices, the range of radio emissions for battery-operated objects is limited to a few kilometers.

Various LP-WAN network technologies have been deployed in the context of operator networks, which also imposes an additional constraint for users of these networks, as each end-device of these networks operates with a subscription to the network operator. These commercial solutions lose their attractiveness in use cases potentially requiring a very large number of end-devices where the amount of communication for each terminal is low or rare, not justifying a subscription.

There is therefore a need for a method of communication between two devices which makes it possible to avoid or mitigate the above disadvantages.

### BRIEF SUMMARY

The present disclosure improves the situation.

According to a first aspect, a method of communication between a first device and a second device is proposed, the first device being a low-power wireless end-device of an LP-WAN type data communication network, and the second device being a low-power wireless device that is not a node of the LP-WAN type data communication network, the first device being configured to behave as a relay node with respect to the second device, the method being implemented by the first device and comprising: receiving a wake-up message from the second device, via an application layer of the first device, on one or more frequency channels defined for wireless communications between the first device and the second device; transmitting, to the second device, via the application layer of the first device, a receipt acknowledge message of the wake-up message; receiving a data packet from the second device, via the application layer of the first device (for example on a frequency channel announced by the wake-up message); and transferring, to an application server, via a node of the LP-WAN type data communication network, data from the data packet which are inserted in an uplink data transmission message in a communication protocol of the LP-WAN type data communication network.

By using an application layer of a low-power wireless end-device of an LP-WAN type data communication network configured for the implementation of data exchanges according to the present disclosure, the proposed method advantageously makes it possible to avoid requiring a subscription to a public network for all objects in a fleet, in particular when objects already connected to the public network are of sufficient density. Indeed, the proposed method defines a new relay type of mode at the application level, which advantageously allows relaying data in payload data messages in a manner that is transparent to the operator of the public network.

The proposed method according to the first aspect may advantageously be implemented within any LP-WAN type data communication network, for example such as a data communication network comprising a LoRaWAN type of network. The first device, configured to implement an embodiment of a proposed method, may for example be a device configured as an end-node of a LoRaWAN type of network and may further be configured to implement certain relay node functionalities of a LoRaWAN type of network in an application layer configured within the device. For example, the first device configured to implement an embodiment of a proposed method may be a device configured as an end-node of a LoRaWAN type of network and configured with a software application configured to implement certain relay node functionalities of a LoRaWAN type of network. The LP-WAN type data communication network may thus comprise, in one or more embodiments, a network configured to implement one or more functionalities of one of the LoRaWAN standards as published by the LoRa Alliance consortium, and/or their evolutions. In this context, an application relay type of mode is proposed by the present disclosure, which is distinguished from the relay mode specified by the LoRa Alliance consortium which uses frames at the sub-layer level of media access control (MAC), called “MAC commands,” which as specified are usable only by the network operator for relaying messages from a second device.

The features set forth in the following paragraphs may optionally be implemented. They may be implemented independently of one another or in combination with one another.

In one or more embodiments, the proposed method may further comprise: transmitting, to the second device, a configuration command message comprising a command to switch to a transponder type of operating mode. In one or more embodiments, this method may further comprise: transmitting, to a location server configured to receive data from an LP-WAN type data communication network, data exchanged with the second device in radar mode.

In one or more embodiments, the proposed method may further comprise: listening in order to detect radio signals transmitted on one or more wake-up frequency channels during listening periods, detecting radio activity during a listening period among the listening periods, and switching to a reception mode in order to receive the wake-up message.

In one or more embodiments, the proposed method may further comprise: determining, via the application layer of the first device, whether the second device corresponds to one or more devices listed in a predefined list of devices.

According to another aspect, a method of communication between a first device and a second device is proposed, the first device being a low-power wireless end-device of an LP-WAN type data communication network, and the second device being a low-power wireless device that is not a node of the LP-WAN type data communication network, the method being implemented by the second device, and comprising: transmitting, to an application layer of the first device, a wake-up message on a frequency channel defined for wireless communications between the first device and the second device; receiving, from the application layer of the first device, a receipt acknowledge message of the wake-up message; and transmitting a data packet to the application layer of the first device (for example on a frequency channel announced by the wake-up message).

In one or more embodiments, this proposed method may further comprise: receiving, from (the application layer of) the first device, a configuration command message comprising a command to switch to a transponder type of operating mode.

In one or more embodiments of one of the methods proposed in the present disclosure, the data communication network may comprise a LoRaWAN type of network, and the first device may be an end-node of the LoRaWAN type of network which is configured to implement, at the application level (via its application layer), relay node functionalities of the LoRaWAN type of network. In one or more embodiments, one or more among the wake-up message, the acknowledgment message, and the uplink data transmission message may be messages in the LoRaWAN Relay protocol. For example, in one or more embodiments, the wake-up message may be a “Wake-On-Radio Relay Join-Request” message of the LoRaWAN Relay protocol, the acknowledgement message may be a “Wake-On-Radio Acknowledge” message of the LoRaWAN Relay protocol, and the uplink data transmission message may be a “Class A” message of the LoRaWAN Relay protocol.

In one or more embodiments of one of the methods proposed in the present disclosure, the wake-up message may comprise a hash code obtained by cryptographic hashing of an extended universal identifier (EUI) of the second device.

According to another aspect, a wireless communication device is provided comprising: a radio transceiver; a memory; and at least one processor operably coupled to the radio transceiver and to the memory, and configured for the implementation of an embodiment of a method as proposed in the present disclosure.

According to another aspect, a method is provided for determining the location of devices, implemented by a location server configured to receive data from an LP-WAN type data communication network, the method comprising: obtaining location information for a first device, the first device being a low-power wireless end-device of the LP-WAN type data communication network; receiving, from the first device, a data packet comprising an identifier of a second device, the second device being a low-power wireless device that is not a node of the LP-WAN type data communication network; and determining location information for the second device on the basis of the location information for the first device.

In one or more embodiments, this proposed method may further comprise: transmitting, to the first device, a control command requesting that the first device transmit to the second device a configuration control message comprising a command to switch to a radar type of operating mode. In one or more embodiments, this proposed method may further comprise: receiving, from the first device, data exchanged with the second device in radar mode. In one or more embodiments, this proposed method may further comprise: determining a pinpointed location of the second device on the basis of the data exchanged by the first device with the second device in radar mode.

According to another aspect, a computer server is provided comprising: a memory; at least one processor operably coupled to the memory, and configured to implement an embodiment of a method for determining a location as proposed in the present disclosure.

According to another aspect, a non-transitory storage medium for a computer-executable program is provided, comprising a set of data representing one or more programs, said one or more programs comprising instructions which, upon the execution of said one or more programs by a computer comprising a processing unit operably coupled to memory means and to an input/output interface module, cause the computer to implement a method proposed in the present disclosure.

According to another aspect, a computer server is provided, which comprises: a processor and a memory operably coupled to the processor, the processor being configured to implement an embodiment of a proposed method.

According to another aspect, a computer program is provided, loadable into a memory associated with a processor, and comprising portions of code for the implementation of one or more embodiments of a method as proposed in the present disclosure upon the execution of said program by the processor.

Another aspect relates to a set of data representing, for example via compression or encoding, a computer program as provided herein.

According to another aspect, a non-transitory storage medium for a computer-executable program is provided, which comprises a set of data representing one or more programs, said one or more programs comprising instructions which, upon the execution of said one or more programs by a computer comprising a processing unit operably coupled to memory means and to an input/output interface module, cause the computer to implement one or more embodiments of a method as proposed.

According to another aspect, a computer program is provided comprising instructions for implementing all or part of a method as provided herein when this program is executed by a processor.

According to another aspect, a non-transitory computer-readable storage medium is provided on which such a program is stored.

### BRIEF DESCRIPTION OF DRAWINGS

Other features, details and advantages will become apparent upon reading the following description of some non-limiting exemplary embodiments, Referring to the appended drawings, in which:

FIG. 1 shows an example of a communication system for implementing a proposed method according to one or more embodiments.

FIG. 2a shows a diagram illustrating one exemplary implementation of a proposed method for a first device according to one or more embodiments.

FIG. 2b shows a diagram illustrating one exemplary implementation of a proposed method for a second device according to one or more embodiments.

FIG. 2c shows a diagram illustrating one exemplary implementation of a proposed method for a computer server according to one or more embodiments.

FIG. 3 shows a diagram illustrating one non-limiting example of message exchanges between a first device and a second device, according to a proposed method according to one or more embodiments.

FIG. 4a shows a diagram illustrating an example of the architecture of a first device for the implementation of a proposed method according to one or more embodiments.

FIG. 4b shows a diagram illustrating an example of the architecture of a second device for the implementation of a proposed method according to one or more embodiments.

### DETAILED DESCRIPTION

In the following detailed description of some embodiments of the invention, numerous specific details are presented in order to provide a more complete understanding. However, those skilled in the art will be aware that some embodiments may be put into practice without these specific details. In other cases, well-known features are not described in detail so as to avoid unnecessarily complicating the description.

The present description refers to systems, sub-systems, functions, engines, units, modules, platforms, and diagrammatic illustrations of methods and devices according to one or more embodiments. Each of the described systems, sub-systems, functions, engines, modules, platforms, units and diagrammatic illustrations may be implemented in hardware, software (including embedded software (firmware) or middleware), microcode, or any combination thereof. In the case of a software implementation, the systems, sub-systems, functions, engines, units, modules, platforms, and/or diagrammatic illustrations may be implemented by computer program instructions or software code, which may be stored or transmitted on a computer-readable medium, including a non-transitory medium, or a medium loaded into the memory of a generic or dedicated computer or any other programmable data processing apparatus or device so as to produce a machine, such that the computer program instructions or software code executed on the computer or programmable data processing apparatus or device constitute means for implementing these systems, sub-systems, functions, engines, units, modules, platforms, and/or diagrammatic illustrations.

Embodiments of a computer-readable medium include, but are not limited to, computer storage media and communication media, including any medium facilitating the transfer of a computer program from one location to another. “Computer storage medium/media” is understood to mean any physical medium that can be accessed by a computer. Examples of computer storage media include, but are not limited to, flash memory disks or components or any other flash memory devices (for example USB flash drives, memory cards, memory sticks, thumb drives), CD-ROMs or other optical data storage devices, DVDs, magnetic disk data storage devices or other magnetic data storage devices, data memory components, RAM, ROM, EEPROM, smart cards, SSD (Solid State Drive) memories, and any other form of media usable for transporting or storing or saving data or data structures that can be read by a computer processor.

Additionally, various forms of computer-readable media may transmit or carry instructions to a computer such as a router, gateway, server, or any data transmission device, whether this involves wired (coaxial cable, fiber optics, telephone wires, DSL cable, or Ethernet cable), wireless (infrared, radio, cellular, microwave), or virtualized transmission devices (virtual router, virtual gateway, virtual tunnel endpoint, virtual firewall). The instructions may, depending on the embodiments, include code of any computer programming language or computer program element, such as, without limitation: assembly language, C, C++, Visual Basic, HyperText Markup Language (HTML), Extensible Markup Language (XML), HyperText Transfer Protocol (HTTP), Hypertext Preprocessor (PHP), SQL, MySQL, Java, JavaScript, JavaScript Object Notation (JSON), Python, and bash scripting.

Furthermore, the terms “in particular,” “for example,” “exemplary,” and “typically” are used in the present description to designate examples or illustrations of non-limiting embodiments, which do not necessarily correspond to embodiments that are preferred or advantageous over other possible aspects or embodiments.

The terms “operably coupled,” “coupled,” “mounted,” “connected,” and their various variants and forms used in the present description refer to couplings, connections, and assemblies, which may be direct or indirect, and in particular comprise connections between electronic devices or between portions of such devices which enable the operations and functions as described in the present description. Furthermore, the terms “connected” and “coupled” are not limited to physical or mechanical connections or couplings. For example, an operably coupled connection may include one or more wired connections and/or one or more wireless connections between two or more devices which enable simplex and/or duplex communication links between the devices or portions of the devices. In another example, an operably coupled coupling or a connection may include a wired and/or wireless coupling to enable data communications between a server of the proposed system and another device of the system.

“Server” in the present description is understood to mean any service point (virtualized or not) or device providing data processing, one or more databases, and/or data communication functions. For example, and without limitation, the term “server” may refer to a physical processor operably coupled with associated communications, data storage, and database functions, or may refer to a network, group, assembly, or complex of processors, and the associated data storage and networking devices, as well as an operating system and one or more database systems and application software supporting the services and functions provided by the server.

The terms “network” and “communication network” as used in the present description refer to one or more data links that can couple or connect devices, possibly virtualized, so as to enable the transport of electronic data between computer systems and/or modules and/or other electronic devices or device. A network may comprise, in whole or in part, the Internet, one or more local area networks (LANs), one or more wide area networks (WANs), wired connections, wireless connections, cellular connections, or any combination of these different networks.

The terms “application layer” and “application” as used in the present description refer to an implementation by an application layer (for example as defined in the OSI model) configured in a device. Communication mechanisms offered to the user's applications may typically be implemented by the application layer. The application layer may comprise an access point to network services. The application layer may represent data for the user as well as encoding and dialog control. In one or more embodiments, the application layer may correspond to a means of communication (of data, such as messages for example) on any communication channel between an end-device and a server (for example an application server), the server being accessible by any node of the LP-WAN network, as opposed to infrastructure messages internal to the LP-WAN network which are not accessible to the end user.

The term “application” as used in the present description designates any tool which functions and is operated by means of a computer, in order to provide or execute one or more function(s) or task(s) for a user or another application program. To interact with an application, and to control it, a user interface (for example a graphical user interface or GUI) may be provided on the device on which the application is implemented.

The term “terminal” is used in the present description to designate any entity, such as a software entity, capable of establishing or receiving communications based on the use of one or more transport protocols, for example such as the protocols Message Queuing Telemetry Transport (MQTT), Transmission Control Protocol (TCP), and User Datagram Protocol (UDP), and/or any entity adapted to function as an endpoint of a communication established according to the procedures of a communication protocol, such as, but not limited to, an LP-WAN network protocol, for example the LoRaWAN protocol. For a given communication, a terminal which implements a communication protocol may act as a client, a server, or both. Examples of terminals include, but are not limited to, connected objects, fixed or mobile terminals, smart terminals (smart phones), personal computers (PC), tablets, Internet servers, etc.

The term “packet,” as used in the present description, designates in a non-limiting manner any data unit capable of being transported or transmitted between two network nodes, two stations, two terminals, or across one or more data networks. A “packet” may designate one or more frames, one or more protocol data units (PDU), one or more datagrams, or any other data unit. A packet for example may include a group of bits, which may include one or more address fields, one or more control (or signaling) fields, and/or one or more fields of payload data.

“LP-WAN type of network,” or abbreviated as “LP-WAN network” or “LP-WAN,” is understood to mean any low-power wide area data communication network used in the field of the Internet of Things and/or in inter-machine communication, or any protocol used for data communication between two network nodes.

Although the exemplary embodiments described below are illustrated with an example of an LP-WAN type data communication network comprising a LoRaWAN type of network, those skilled in the art will understand that this example is not limiting, as the proposed method may also be implemented, in other embodiments, using other types of LP-WAN network, for example such as a Mioty network or a SigFox network.

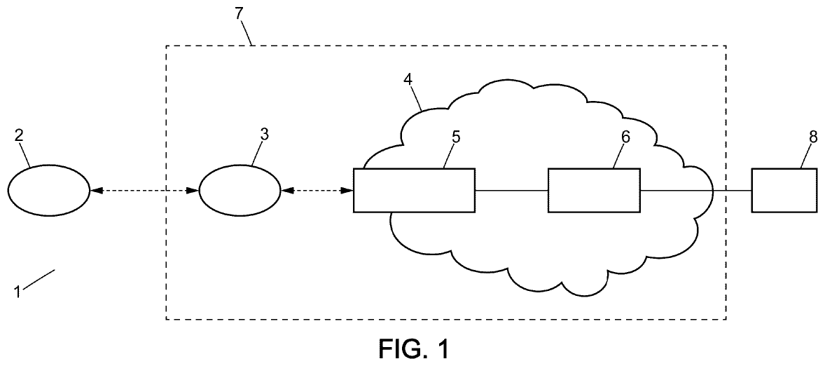

FIG. 1 illustrates an example of a communication system (1) in which one or more embodiments of the proposed methods and devices may be implemented.

System 1 comprises a second device 2 and an LP-WAN type data communication network 7. LP-WAN data communication network 7 comprises a first device 3 configured to implement data communications with an application server 8 via a network server 6 and a network gateway 5 of a data communication network 4. In the example illustrated in FIG. 1, second device 2, first device 3, network gateway 5, network server 6, and application server 8 are devices configured to be operably coupled for data communications between first device 3 and application server 8 according to one or more embodiments of the present disclosure.

In one or more embodiments, first device 3 is a wireless end-device of a LP-WAN data communication network 7 of the LP-WAN type. First device 3 may thus be configured to carry out wireless data communications (on the air interface) according to any appropriate protocol with network gateway 5. For example, in one or more embodiments, first device 3 may be a low-power wireless end-device of LP-WAN network 7. In one or more embodiments, the first device may further be configured to perform wireless data communications (on the air interface) with second device 2 according to any appropriate protocol.

Advantageously, in one or more embodiments, the first device may for example be a device subscribed to a user device type of LP-WAN network. Thus, the proposed method does not require the first device to be configured to implement one or more characteristics of a “network device” that is part of the operator's infrastructure, i.e., having the permissions to issue network commands accessible only to infrastructure devices, as opposed to user devices. The proposed method may thus advantageously be implemented in a first device which is, from the point of view of the LP-WAN network, a user type of device (end-device), as opposed to a network infrastructure device, for example such as a relay node of the LP-WAN network.

In one or more embodiments, second device 2 may be configured to carry out wireless data communications (on the air interface) according to any appropriate protocol with first device 3 of LP-WAN network 7. However, as illustrated in FIG. 1, in one or more embodiments, second device 2 is not a node of LP-WAN network 7.

Thus, in one or more embodiments, it is possible to envisage a first device 3 which is a device (a node) of LP-WAN network 7 and which therefore has the authorizations to communicate over LP-WAN network 7 with other devices of the network (for example, in the case where the LP-WAN network is operator-run, first device 3 may be associated with a subscription to the LP-WAN network), and a second device 2 which, unlike first device 3, is not a device (a node) of LP-WAN network 7.

The proposed method may thus for example be implemented by an end user who has access to a fleet of devices, among them a first device 3 which is a device of LP-WAN network 7 and a second device 2 which is not a device of LP-WAN network 7, the first and second devices being configured to implement embodiments of the proposed method.

In one or more embodiments, first device 3 may further be configured, for example in the application layer of embedded software, to behave as a relay node in relation to second device 2. In one or more embodiments, first device 3 may further be configured, for example in the application layer of embedded software, to behave as a relay node of the LP-WAN type data communication network, in relation to second device 2. In some embodiments, given that first device 3 is an end-device of LP-WAN network 7, certain relay node functionalities of LP-WAN network 7 may be implemented at the application level of first device 3 (since the network level will be configured with the end-device functionalities of LP-WAN network 7). Thus, in one or more embodiments, first device 3 may be configured to provide certain relay node functionalities of LP-WAN network 7 by a relay mode instantiation configured at the application level of first device 3.

As a non-limiting example, the LP-WAN type data communication network may be a LoRaWAN type of network, and the first device may be an end-node or an end-device of the LoRaWAN network, configured to implement relay node functionalities of a LoRaWAN network, for example by instantiation of these functionalities at the application level of first device 3. For example, in one or more embodiments, the first device may be configured in the network layer (in the OSI model according to the IEEE 802 computer network standards), or in one or more other lower layers in the OSI model, to implement the functionalities of a LoRaWAN network end-device, as specified by the LoRa Alliance in the LoRa specification (for example, version 1.0.x or 1.1.x of the LoRaWAN specification available at https://resources.lora-alliance.org/technical-specifications), and may further be configured at the application level to implement certain aspects of the relay mechanism specified in the “LoRaWAN Relay Specification TS011-1.0.0” (or any evolution of this specification) which are used for implementing an embodiment of a proposed method. First device 3 may thus, for example, be a LoRaWAN network end-device, configured with a relay mode at the application level in order to implement LoRaWAN relay functionalities defined in the “LoRaWAN Relay Specification TS011-1.0.0,” which advantageously makes it possible to use some of the functionalities of a LoRaWAN relay within a device which remains, from the point of view of the LoRaWAN network to which it belongs, an end-device and not a relay type of network device.

In one or more embodiments, LP-WAN network 7 may thus be a LoRaWAN type of network, and first device 3 of LP-WAN network 7 may be an end-device of the LoRaWAN network, configured to implement one or more of the relay functionalities of the LoRaWAN network, for example by an instantiation of these functionalities at the application level of first device 3.

The implementation of relay functions by first device 3 may advantageously be used to relay data received from second device 2 to network server 6 via first device 3, for example by using a tunnel mechanism, while second device 2 is not a node of the LP-WAN network 7 to which network server 6 belongs. Data from a device 2 that does not belong to LP-WAN network 7 may thus be routed to one 6 of the servers of LP-WAN network 7.

Thus, advantageously, second device 2, which may be one of the communicating devices of a fleet of devices of the end user without being a device of LP-WAN network 7, is able to transmit data which are routed to one 6 of the servers of LP-WAN network 7 by using first device 3 as a relay, without requiring that they themselves be part of LP-WAN network 7.

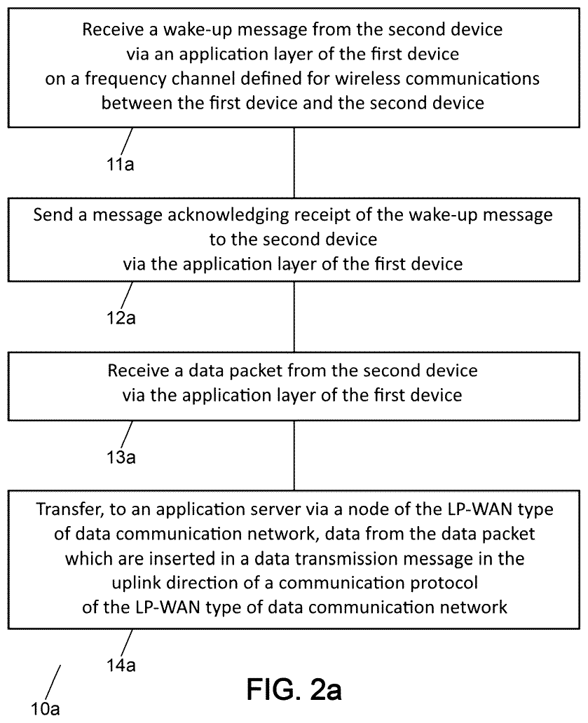

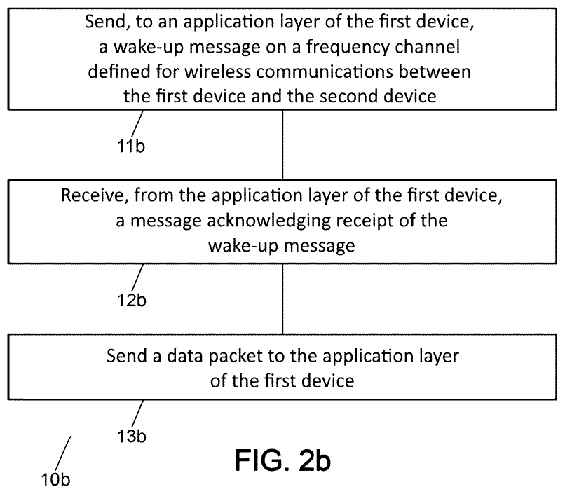

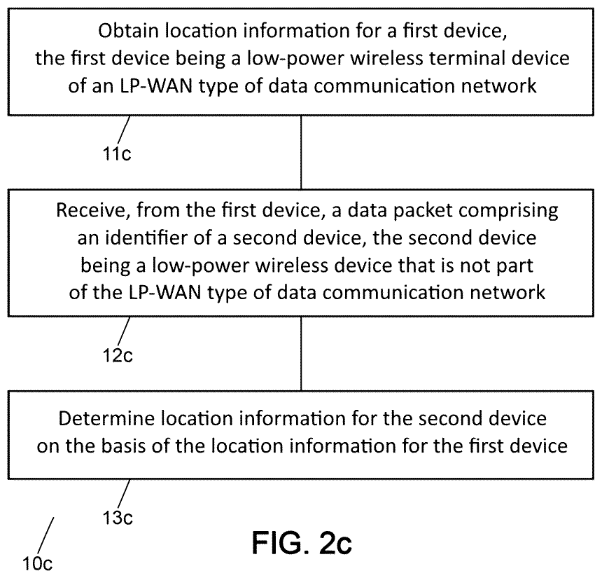

FIG. 2a illustrates a non-limiting exemplary implementation (10a), by the first device, of a proposed method according to one or more embodiments.

Referring to FIG. 2a, we consider a first device and a second device, the first device being a low-power wireless end-device of an LP-WAN type data communication network, and the second device being a low-power wireless device which does not belong to the LP-WAN type data communication network. For example, the first device, the second device, and the LP-WAN type data communication network, may respectively be implemented by first device 3, second device 2, and LP-WAN network 7 which are illustrated in FIG. 1.

In one or more embodiments, the first device may be configured, for example at the application level, to behave as a relay node with respect to the second device. For example, the first device may be a low-power wireless end-device of an LP-WAN type data communication network, i.e., may be a user node device of an LP-WAN type data communication network, but may be configured, for example at the application level, to emulate one or more functions of a relay node of the LP-WAN type data communication network which are used to implement an embodiment of a proposed method.

In one or more embodiments, the first device may be configured to receive 11a a wake-up message from the second device, via an application layer of said first device.

In some embodiments, the first device may be configured to receive the wake-up message on a frequency channel (or several frequency channels) defined for wireless communications between the first device and the second device. In these embodiments, the wake-up message received from the second device may thus also be a synchronization message for synchronizing the first device and the second device.

In one or more embodiments, the application layer of the first device may further be configured to transmit 12a an application receipt acknowledge message of the wake-up message to the second device, for example upon receipt of the wake-up message. In one or more embodiments in which the received message acts as a wake-up message and synchronization message, the application receipt acknowledge message of the wake-up message and synchronization message may further act as a synchronization message for synchronizing with the second device, in that the second device may transition to a state synchronized with the first device upon receipt of this acknowledgment. For example, the second device may consider receipt of the acknowledgment as informing it that the first device has agreed to wireless communications on the frequency channel announced in the wake-up message.

In one or more embodiments, the application layer of the first device may further be configured to receive 13a a data packet from the second device, for example on a frequency channel announced by the wake-up message, in a synchronized or non-synchronized manner depending on the embodiment.

In one or more embodiments, the application layer of the first device may be configured so that the first device operates as a transmission relay for the data packet received from the second device. Thus, the application layer of the first device may be configured to transfer 14a, to a node of the LP-WAN type data communication network, data from the data packet which are inserted in an uplink data transmission message in a communication protocol of the LP-WAN type data communication network. For example, the data packet may be relayed to the LP-WAN type data communication network by being inserted in an uplink data transmission message in a communication protocol of the LP-WAN type data communication network.

In one or more embodiments, the application layer of the first device may be configured to transfer data from the data packet received from the second device to an application server, across the LP-WAN type data communication network, by transferring this data to a node of the LP-WAN network.

The first device thus behaves as an application relay configured within an end-device of the LP-WAN type data communication network, and is advantageously capable of relaying the data received from second device 2 to an application server by using the LP-WAN type data communication network. Since the second device is not a node of the LP-WAN type data communication network, no subscription of the second device to the LP-WAN type data communication network is required.

This advantageously makes it possible to define two operating modes for the second device:

A first operating mode, referred to as nominal mode, in which the second device only uses the “application” relays of the fleet according to one or more embodiments of the present disclosure, for reasons of economy. Connectivity is then opportunistic, depending on the proximity of the “application” relays of the fleet.

A second operating mode, referred to as emergency mode: In the event of an emergency (for example when a vehicle carrying a second device is stolen), a subscription to the LP-WAN network may be used so that the second device can benefit from it for data communications across the entire coverage of the public LPWAN network. In emergency mode, the data packet of the second device, which may be compliant with LoRa standards in a context of a LoRaWAN network, may also be picked up at any time by the LP-WAN network once its user has subscribed to the LPWAN network, in order to benefit from an enhanced coverage.

Thus, in one or more embodiments, the first device may be configured, in its application layer, to reproduce the operations of a relay of an LP-WAN type data communication network, in that it transmits on and therefore relays the data packet received from the second device, to the LP-WAN type data communication network, while the first device is only an end-device of the LP-WAN type data communication network from the point of view of that network.

This advantageously makes it possible to transmit data from the second device to the LP-WAN type data communication network, for example to a server of that network, even though the second device is not a part of, i.e., is not a node of, the LP-WAN type data communication network.

Thus, in the case of an LP-WAN type data communication network managed by a network operator, data from a device that is not a node of the network may be obtained by an end-device of the network, which advantageously may be configured to relay these data to a server of the network, for example at the application level.

For example, in one or more embodiments, a low-power wireless end-device of an LP-WAN network may be provided with an application configured to implement as software a method proposed in the present disclosure.

In one or more embodiments, the first device may further be configured to transmit, to the second device, a configuration command message comprising a command to switch to a transponder type of operating mode. Transponder operation is understood to mean an operating mode in which the first device is configured to respond automatically, by means of a radio transceiver of the first device, to an external signal, for example from a radar, a location determination system, etc.

Thus, in certain embodiments, when data communication has been carried out between the first and second device, the first device may control the second device so that the second device switches to transponder mode. In these embodiments, the second device is thus configured to be able to switch to a transponder type of operating mode, i.e., to an operating mode in which it responds to radio frequency messages authenticated by a radio frequency “echo” which is precisely offset relative to the reception of the first by an order of precision corresponding to a few meters of radio propagation, thus enabling a precise distance assessment by the transmitter in the manner of a radar, and thus enabling a determination of the location of the second device that is completely independent of the LPWAN network, by successive distance measurements. For example, a stolen vehicle may be located out of range of the LPWAN network with a device of type 2. It cannot be located. But randomly, a vehicle in the fleet equipped with a relay will detect the wake-up messages from the second device, then relay its application messages. The network application server, noting that this is a stolen vehicle, can then activate the responder mode of the second device. From that point on, any vehicle equipped with the location message transmitter function can find the stolen vehicle once it is within the vicinity of the stolen vehicle, even if the latter is intentionally hidden out of range of the network.

Data may then be exchanged between the first device and the second device operating in radar mode. In one or more embodiments, these data may advantageously be relayed to a location server, for example by means of one or more nodes of the LP-WAN type data communication network, which makes it possible to determine the location of the second device by using the data exchanged with the first device which is an end-device of the LP-WAN type data communication network.

In one or more embodiments, the proposed method may advantageously be used to perform proximity detection of the second device, when the first device, which may for example be on board a mobile vehicle, is in the vicinity of the second device.

For example, in one or more embodiments, the first device may further be configured to listen in order to detect radio signals transmitted on one or more wake-up frequency channels during listening periods, to detect radio activity during a listening period among the listening periods, and to switch to a reception mode in order to receive the wake-up message.

In these embodiments, the first device may thus be provided with a wireless transceiver device configured to listen in order to detect radio signals transmitted on one or more wake-up frequency channels during listening periods, the wake-up frequency channels being preconfigured on the first and second device so as to allow frequency synchronization of data exchanges between the first device and the second device.

As the first device and the second device are low-power devices, they may be configured to allow time synchronization of data communications.

For example, the first device may be configured to listen, for example periodically or substantially periodically, in order to detect radio signals over a potentially very short predefined listening period (for example 1 ms every 2 seconds), and the second device may be configured to transmit, for example periodically or substantially periodically, a radio signal (carrying data, such as a preamble for example) on the wake-up frequency channel(s) during a predefined transmission period, typically chosen to be longer than the predefined listening period (for example 2.5 seconds).

In one or more embodiments, the first device may further be configured to switch to a reception mode, upon detection of radio activity during a listening period, in order to receive the wake-up message and to implement the proposed method, an exemplary embodiment of this being illustrated in FIG. 2a.

In one or more embodiments, the use of a proposed method for a use case of determining the location of the second device or detecting the proximity of the second device may be enhanced by using a predefined list of devices, and by determining, for example via the application layer of the first device, whether the second device corresponds to one or more devices listed in the predefined list of devices.

In some embodiments, when it is determined that the second device corresponds to one or more devices listed in the predefined list of devices, the first device may control the second device so that the second device switches to an operating mode (for example transponder mode) enabling it to be geographically located.

Conversely, in some embodiments, when it is determined that the second device does not correspond to any of the devices listed in the predefined list of devices, the first device may interrupt the operations which aim to control the second device, for example for locating it geographically.

FIG. 2b illustrates one non-limiting example of an implementation 10b by the second device of a proposed method according to one or more embodiments.

Referring to FIG. 2b, a first device and a second device are considered, the first device being a low-power wireless end-device of an LP-WAN type data communication network, and the second device being a low-power wireless device that is not a node of the LP-WAN type data communication network. For example, the first device, the second device, and the LP-WAN type data communication network may respectively be implemented by first device 3, second device 2, and LP-WAN network 7 which are illustrated by FIG. 1.

In one or more embodiments, the second device may be configured to transmit 11b a wake-up message to an application layer of the first device. In certain embodiments, the second device may be configured to transmit the wake-up message on a frequency channel (or several frequency channels) defined for wireless communications between the first device and the second device. The wake-up message sent by the second device may thus also act as a synchronization request message between the first device and the second device.

In one or more embodiments, the second device may further be configured to receive 12b, from the application layer of the first device, a receipt acknowledge message of the wake-up message. In one or more embodiments in which the transmitted message acts as a wake-up message and synchronization message, the application receipt acknowledge message of the wake-up message received by the second device may further act as a synchronization message for synchronizing with the second device, in that the second device may transition to a state that is synchronized with the first device upon receipt of this acknowledgment. For example, the second device may consider the receipt of the acknowledgment as informing it that the first device agrees to wireless communications on the frequency channel announced in the wake-up message. In one or more embodiments, the second device may further be configured to transmit 13b a data packet to the application layer of the first device, for example on a frequency channel announced by the wake-up message.

In one or more embodiments, the second device may be configured to behave, in relation to the relay functions emulated by the first device, as an end-device of the LP-WAN type data communication network but without being a node of that network. This advantageously makes it possible to exchange data with the second device without a subscription for the second device being necessary in cases where the LP-WAN type data communication network is an operator network.

It is thus possible to envisage use cases of a proposed method in which a large number of corresponding devices for implementing an embodiment of a proposed method are deployed, enabling for example proximity detection or a determination of the location of each of these devices by implementing an embodiment of a proposed method.

For example, the second device may be implemented within a tracker installed on a vehicle (such as a bicycle, scooter, automobile, etc.) in order to geolocate the vehicle in the event of a theft.

In the embodiments in which the second device is a tracker on board a vehicle, the proposed method may advantageously be used in the event of a theft of the vehicle, in particular when the stolen vehicle is stored in a location that is not very accessible to radio frequency signals, for example such as a basement, where location determination by GPS (Global Positioning System) or any other satellite location system, or by radio frequency signals (for example WiFi (Wireless Fidelity) signals), cannot be used. In such case, the first device may advantageously be on board a vehicle that travels to target locations in order to detect the tracker when the latter is nearby.

FIG. 2c illustrates one non-limiting exemplary implementation (10c) by a computer server (for example a location server) of a proposed method according to one or more embodiments.

Referring to FIG. 2c, a computer server is considered which is configured to receive data from a LP-WAN type data communication network, for example LP-WAN network 7 illustrated in FIG. 1. For example, the computer server may be implemented by network server 6 illustrated in FIG. 1, or by any computer server which is connected so as to exchange data with the nodes of LP-WAN network 7, for example via network server 6.

In one or more embodiments, the computer server may be configured to obtain 11c location information from a first device, the first device being a low-power wireless end-device of the LP-WAN type data communication network.

According to this embodiment, the first device being an end-device of the LP-WAN network, the location data may be calculated by the computer server on the basis of data received by the computer server, or may be received by the computer server, for example from the first device.

In one or more embodiments, the computer server may further be configured to receive 12c, from the first device, a data packet comprising an identifier of a second device, the second device being a low-power wireless device that is not a node of the LP-WAN type data communication network.

For example, in certain embodiments, identification data identifying a second low-power wireless device that is not a node of the LP-WAN data communication network (and in particular is not an end-device of the LP-WAN data communication network), may have been obtained by the first device by implementing an embodiment of the proposed method for the first device.

In one or more embodiments, the computer server may further be configured to determine 13c location information for the second device on the basis of the location information for the first device.

For example, the computer server may be configured to determine a location of the second device, once the second device has been identified, on the basis of the location obtained for the first device. This determination may for example take advantage of the fact that the first and second devices are low-power devices for which the proposed methods may be used for proximity detection of the second device by the first device.

In one or more embodiments, the computer server may further be configured to transmit a control command to the first device, to request that the first device transmit to the second device a configuration command message comprising a command to switch to a radar type of operating mode.

Control of the second device by the first device may thus be carried out under the control of the computer server, in particular to take into account the fact that in one or more embodiments, the computer server may be configured to control a fleet of a plurality of deployed first devices, and/or to manage a database of second devices, some of these second devices being identified as needing to be located.

In these embodiments, the first device may be configured to relay data exchanged with the second device in radar mode, where applicable, and the computer server may be correspondingly configured to receive, from the first device, data exchanged with the second device in radar mode.

The computer server may further be configured, in certain embodiments, to determine a pinpointed location of the second device on the basis of the data exchanged by the first device with the second device in radar mode.

Determining a pinpointed location of the second device may thus be obtained after proximity detection of the second device by the first device, on the basis of data provided by the first device to the computer server.

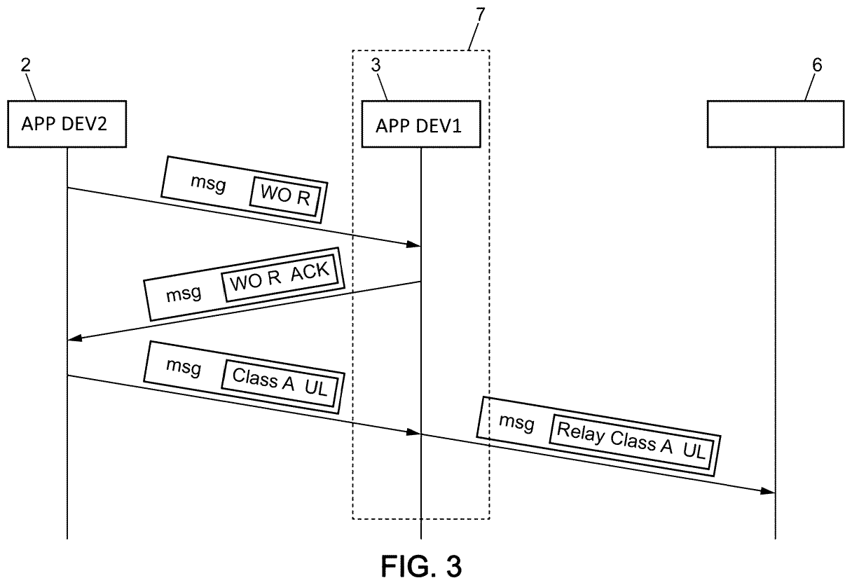

FIG. 3 shows a diagram illustrating a non-limiting example of message exchanges between a first device and a second device, according to a proposed method according to one or more embodiments.

Referring to FIG. 3, a first device 3 and a second device 2 are considered, first device 3 being a low-power wireless end-device of an LP-WAN type data communication network 7, and second device 2 being a low-power wireless device that is not a node of the LP-WAN type data communication network 7. For example, the first device, the second device, and the LP-WAN type data communication network may respectively be implemented by first device 3, second device 2, and LP-WAN network 7 which are illustrated in FIG. 1.

In particular, first device 3 may be an end-device of a LoRaWAN network 7 used to perform proximity detection of second device 2 according to a method of the present disclosure.

In one or more embodiments, first device 3 may be configured, for example at the application level, to behave as a relay node in relation to second device 2, even though second device 2 is not a node of LoRaWAN network 7. For example, the first device may be an end-device of LoRaWAN network 7 which is not a relay node of LoRaWAN network 7, but is configured to emulate one or more of the functions of a relay node of LoRaWAN network 7, not in the lower layers of the OSI model (as a LoRaWAN relay node 7 would be), but in the higher layers of the OSI model, for example at the application level, and to use these functions to implement an embodiment of a method proposed in the present disclosure. In one or more embodiments, the transmission and reception of messages for the implementation of relay node functions of LoRaWAN network 7 at the application level may use a mechanism of encapsulating MAC commands exchanged by the nodes of LoRaWAN network 7 within application messages.

In one or more embodiments, second device 2 may be configured, for example at the application level, to transmit a “Wake-On-Radio” or “WOR” type of wake-up message on the air interface, for example by broadcasting this message so as to be detectable by a detection device located nearby. The WOR wake-up message may be broadcast on a frequency channel among one or more frequency channels configured for wireless communications involving the first and second devices. In one or more embodiments, the WOR wake-up message broadcast by second device 2 may be in compliance with the LoRaWAN specification, and in particular may comprise data announcing a frequency channel for transmitting data to a LoRaWAN relay node. Thus, even if second device 2 is not a node of LoRaWAN network 7, this device may be configured to reuse certain messages used by the nodes of LoRaWAN network 7, but at the application level and not at the MAC level, and to behave, in relation to the LoRaWAN relay functions implemented by the first device, as a node that is discoverable by a relay node. In one or more embodiments, the transmission and reception of messages for implementing the exchange of messages between nodes of LoRaWAN network 7 at the application level may use a mechanism of encapsulating MAC commands exchanged by the nodes of LoRaWAN network 7 within application messages.

In FIG. 3, the references 2 and 3 thus respectively designate, in one or more embodiments, the application layer of the second device (“APP DEV2”) and the application layer of the first device (“APP DEV1”).

Referring to FIG. 3, in one or more embodiments, the first device may be configured to broadcast an application message in which the payload comprises a WOR type of LoRaWAN message, for example as specified in section 3.2 of “LoRaWAN Relay Specification TS011-1.0.0.” First device 3 may receive the WOR type of application message being broadcast, for example when it is sufficiently close to second device 2 to be within the radio coverage of the application WOR message being transmitted.

In one or more embodiments, upon receipt of the application WOR message, first device 3 may generate an application acknowledgement message (WOR Ack) based on the information included in the application WOR message received, and may transmit this application acknowledgement message to second device 2.

In one or more embodiments, second device 2, initially in a state that is not synchronized with LoRaWAN network 7, transitions to a synchronized state upon receipt of the application acknowledgement message, which is a state where it can transmit messages on the frequency channel announced in its WOR wake-up message.

In one or more embodiments, upon receipt of the application acknowledgment message, second device 2 may generate and then transmit a data packet on the frequency channel announced by the WOR wake-up message, inserted in an uplink data transmission message of the LoRaWAN protocol, for example such as a “LoRaWAN class A uplink” message. In order to be transmitted at the application level, the “LoRaWAN class A uplink” message may be encapsulated in an application message. The data packet may for example be configured to allow detecting the nearby presence of second device 2, in particular when second device 2 is considered lost.

In one or more embodiments, upon receipt of the “LoRaWAN class A uplink” data transmission message, first device 3, operating in relay mode at the application level in relation to this received message, generates an application message comprising a LoRaWAN network relay uplink frame for transmission in the uplink direction, “Relay class A uplink,” comprising data received from the second device, then transmits this network relay uplink frame encapsulated in the application message to an application server 6 of a data communication network (possibly via one or more nodes of LoRaWAN network 7), which may be configured to process these data according to the intended use case. First device 3 thus transfers data received from second device 2, to application server 6.

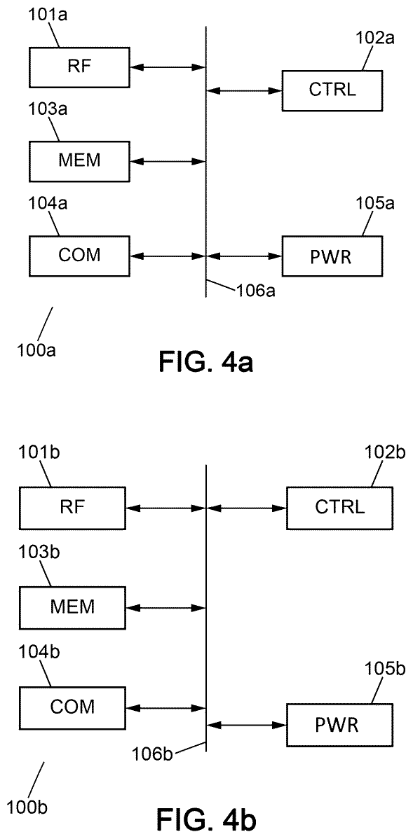

FIG. 4a schematically illustrates an example of a first device configured for the implementation of an embodiment of a proposed method in one or more embodiments.

As illustrated in FIG. 4a, first device 100a may comprise a radio frequency (RF) unit 101a, a controller 102a, a memory 103a, a power supply unit 105a, and a communication unit 104a. Depending on the embodiment, radio frequency (RF) unit 101a, memory 103a, power supply unit 105a, and communication unit 104a may be operably coupled to controller 102a by a communication bus 106a, or by any communication link, possibly comprising one or more hardware connectors. In the exemplary architecture of first device 100a illustrated in FIG. 4a, the assembly of radio frequency (RF) units 101a, controller 102a, memory 103a, operating system 104a, power supply unit 105a, and communication unit 104a forms a first device, which may also include other components, units, functions, not shown in the figure.

Controller 102a may comprise one or more processors, such as a central processing unit (CPU) or other hardware processor, an associated memory (for example, random access memory (RAM), cache memory, flash memory, etc.), and be configurable to manage radio frequency (RF) unit 101a, memory 103a, power supply unit 105a, and communication unit 104a, so as to control the use of first device 100a according to one or more embodiments of a proposed method, for example by executing a computer program comprising portions of code for implementing a method as proposed in the present description. Depending on the embodiment, memory 103a and/or an associated memory of controller 102a contain instructions which, when executed by controller 102a, cause controller 102a to carry out or to control the RF unit 101a and communication unit 104a portions so as to perform exemplary implementations of an embodiment of a proposed method described in the present description. Controller 102a may be a component implementing a processor or a computing unit for controlling a first device according to the proposed method and for controlling communication unit 104a of device 100a, such as a microcontroller for example.

Memory 103a preferably comprises non-volatile memory, for example flash memory, and depending on the chosen embodiment, may be implemented in the form of one or more memory components mounted on a circuit board, or in the form of one or more electronic circuits integrated into an electronic component of the first device, or in the form of or integrated into a stand-alone device not necessarily comprising other elements of the first device, for example in the form of a memory card (SD (Secure Digital) memory card, micro SD (Micro Secure Digital) card, SD High Capacity (SDHC), SD Extended Capacity (SDXC)).

Communication unit 104a may be implemented, depending on the chosen embodiment, in the form of one or more software applications or a combination of hardware and software, configured for the implementation of embodiments of the method described in the present description. Communication unit 104a may be configured to implement an application software layer, for the implementation of an embodiment of a proposed method by the first device via one or more applications. Communication unit 104a may also constitute or be part of communication software of the first device. In the following, the term “communication software” will be used to refer to a set of one or more software applications configured for the implementation of a method proposed in the present description. Depending on the architecture of the first device, the communication software is configured to be executable on a processor of the first device, and/or on a processor of an electronic device to which a part of the first device (comprising memory 103a) is connected.

In one or more embodiments, communication unit 104a may be configured to control RF unit 101a, by means of controller 102a, so as to transmit and receive radio frequency signals for the implementation of an embodiment of a proposed method for the first device.

RF unit 101a may be implemented, depending on the chosen embodiment, in the form of one or more software applications or a combination of hardware and software, configured for the implementation of embodiments of the method described in the present description. RF unit 101a may be configured to transmit and receive radio frequency signals, for example in a frequency band and according to a predefined format for the radio frequency signals used by the nodes of an LP-WAN type data communication network. For example, RF unit 101a may be configured to transmit and/or receive radio frequency signals that are in compliance with the specifications for LoRaWAN networks. Furthermore, RF unit 101a may be configured to transmit radio frequency signals at a transmission power that is compatible with a low-power constraint imposed on the first device.

Power supply unit 105a may be implemented, depending on the chosen embodiment, in the form of one or more software applications or a combination of hardware and software, so as to control the supply of power to the first device, which may use a battery or batteries to supply the power, the first device being a low-power device.

First device 100a may be implemented in software form, in which case it takes the form of a program executable by a processor, or in hardware form, such as an application-specific integrated circuit (ASIC), a system on a chip (SOC), or in the form of a combination of hardware and software elements, for example such as a software program intended to be loaded and executed on an FPGA (Field Programmable Gate Array) type of component. SOCs (System On Chip) are embedded systems which integrate all components of an electronic system into a single chip. An ASIC (Application-Specific Integrated Circuit) is a specialized electronic circuit that groups together functionalities that are tailor-made for a given application. ASICs are generally configured during manufacture and the user can only simulate them. FPGA (Field-Programmable Gate Array) programmable logic circuits are electronic circuits that are reconfigurable by the user.

First device 100a mm may also use hybrid architectures, for example such as architectures based on a CPU+FPGA, a GPU (Graphics Processing Unit), or an MPPA (Multi-Purpose Processor Array).

Depending on the embodiment, different architectures of first device 100a may be adopted, for both the hardware portion of the first device and the software portion of the first device where applicable.

For example, in one embodiment, the assembly of elements forming the first device (in the example of FIG. 4a, this assembly comprising radio frequency (RF) unit 101a, controller 102a, memory 103a, power supply unit 105a, and communication unit 104a) may be grouped together in a same device, apparatus, or piece of equipment, such as a vehicle tracking device for example.

In another embodiment, at least some of the elements forming the first device may be distributed over several devices, apparatuses, or pieces of equipment.

In one or more embodiments, communication unit 104a of the first device may be implemented in the form of software (a computer program, comprising instructions in the form of software code (source code, object code, and/or executable code), executable by a processor to which memory 103a (for example an SD card) is connected), possibly integrated into driver software of the first device.

In one or more embodiments, first device 100a is configured to implement a LoRaWAN type of network end-node. For example, communication unit 104a may be configured to implement end-node communication functions as specified by the LoRaWAN standard, and to implement, via an application layer, the operations of the various embodiments of a proposed method for the first device. For example, communication unit 104a may be configured to implement end-node communication functions as specified by the LoRaWAN standard, and further to implement, via an application layer, LoRaWAN network relay node functions, by using a tunneling mechanism to an application server for messages defined by the LoRaWAN standard for a relay node.

Those skilled in the art will understand that the communication method proposed for the first device is not limited to a particular architecture of the first device, and that it may be implemented on devices having a different architecture than those presented above, for example combining the architectures presented above within a hybrid architecture.

FIG. 4b schematically illustrates an example of a second device configured for the implementation of an embodiment of a proposed method in one or more embodiments.

As illustrated in FIG. 4b, second device 100b may comprise a radio frequency (RF) unit 101b, a controller 102b, a memory 103b, a power supply unit 105b, and a communication unit 104b. Depending on the embodiment, radio frequency (RF) unit 101b, memory 103b, power supply unit 105b, and communication unit 104b may be operably coupled to controller 102b by a communication bus 106b, or by any communication link, possibly comprising one or more hardware connectors. In the example architecture of first device 100b illustrated in FIG. 4b, the assembly of radio frequency (RF) units 101b, controller 102b, memory 103b, operating system 104b, power supply unit 105b, and communication unit 104b forms a second device, which may also include other components, units, functions, not shown in the figure.

Controller 102b may comprise one or more processors, such as a central processing unit (CPU) or other hardware processor, an associated memory (for example, random access memory (RAM), cache memory, flash memory, etc.), and be configurable to manage radio frequency (RF) unit 101b, memory 103b, power supply unit 105b, and communication unit 104b, so as to control the use of first device 100b according to one or more embodiments of a proposed method, for example by executing a computer program comprising portions of code for implementing a method as proposed in the present description. Depending on the embodiment, memory 103b and/or an associated memory of controller 102b contain instructions which, when executed by controller 102b, cause controller 102b to carry out or to control the RF unit 101b and communication unit 104b portions so as to perform exemplary implementations of an embodiment of a proposed method described in the present description. Controller 102b may be a component implementing a processor or a computing unit for controlling a first device according to the proposed method and for controlling communication unit 104b of device 100b, such as a microcontroller for example.

Memory 103b preferably comprises a non-volatile memory, for example flash memory, and depending on the chosen embodiment, may be implemented in the form of one or more memory components mounted on a circuit board, or in the form of one or more electronic circuits integrated into an electronic component of the first device, or in the form of or integrated into a stand-alone device not necessarily comprising other elements of the first device, for example in the form of a memory card (SD (Secure Digital) memory card, micro SD (Micro Secure Digital) card, SD High Capacity (SDHC), SD Extended Capacity (SDXC)).

Communication unit 104b may be implemented, depending on the chosen embodiment, in the form of one or more software applications or a combination of hardware and software, configured for the implementation of embodiments of the method described in the present description. Communication unit 104b may be configured for the implementation by the second device of an embodiment of a method proposed in the present disclosure, for example via one or more applications. Communication unit 104b may also constitute or be part of communication software, for example application software, of the second device. Depending on the architecture of the second device, the communication software is configured to be executable on a processor of the second device, and/or on a processor of an electronic device to which a part of the second device (comprising memory 103b) is connected.

In one or more embodiments, communication unit 104b may be configured to control RF unit 101b, by means of controller 102b, so as to transmit and receive radio frequency signals for the implementation of an embodiment of a proposed method for the second device.

RF unit 101b may be implemented, depending on the chosen embodiment, in the form of one or more software applications or a combination of hardware and software, configured for the implementation of embodiments of the method described in the present disclosure. RF unit 101b may be configured to transmit and receive radio frequency signals, for example in a frequency band and according to a predefined format for the radio frequency signals used by the nodes of an LP-WAN type data communication network. For example, RF unit 101b may be configured to transmit and/or receive radio frequency signals that are in compliance with the specifications for LoRaWAN networks. Furthermore, RF unit 101b may be configured to transmit radio frequency signals at a transmission power that is compatible with a low-power constraint imposed on the second device.

Power supply unit 105b may be implemented, depending on the chosen embodiment, in the form of one or more software applications or a combination of hardware and software, so as to control the supply of power to the second device, which may use a battery or batteries to supply the power, the second device being a low-power device.

Second device 100b may be implemented in software form, in which case it takes the form of a program executable by a processor, or in hardware form, such as an application-specific integrated circuit (ASIC), a system on a chip (SOC), or in the form of a combination of hardware and software elements, for example such as a software program intended to be loaded and executed on an FPGA (Field Programmable Gate Array) type of component. SOCs (System On Chip) are embedded systems which integrate all components of an electronic system into a single chip. An ASIC (Application-Specific Integrated Circuit) is a specialized electronic circuit that groups together functionalities that are tailor-made for a given application. ASICs are generally configured during manufacture and the user can only simulate them. FPGA (Field-Programmable Gate Array) programmable logic circuits are electronic circuits that are reconfigurable by the user.

Second device 100b may also use hybrid architectures, for example such as architectures based on a CPU+FPGA, a GPU (Graphics Processing Unit), or an MPPA (Multi-Purpose Processor Array).

Depending on the embodiment, different architectures of second device 100b may be adopted, for both the hardware portion of the second device and the software portion of the second device where applicable.

For example, in one embodiment, the assembly of elements forming the second device (in the example of FIG. 4b, this assembly comprising radio frequency (RF) unit 101b, controller 102b, memory 103b, power supply unit 105b, and communication unit 104b) may be grouped together in a same device, apparatus, or piece of equipment, for example such as a discoverable tracking device with opportunistic connectivity.

In another embodiment, at least some of the elements forming the second device may be distributed over several devices, apparatuses, or pieces of equipment.

In one or more embodiments, communication unit 104b of the second device may be implemented in the form of software (a computer program, comprising instructions in the form of software code (source code, object code, and/or executable code), executable by a processor to which memory 103b (for example an SD card) is connected), possibly integrated into driver software of the first device.

In one or more embodiments, second device 100b is configured to implement a method comprising: transmitting, to the first device, a wake-up message on a frequency channel defined for wireless communications between the first device and the second device; receiving, from the first device, a receipt acknowledge message of the wake-up message; and transmitting, to the first device, a data packet on the frequency channel announced by the wake-up message.

Those skilled in the art will understand that the communication method proposed for the second device is not limited to a particular architecture of the second device, and that it may be implemented on devices having an architecture different from those presented above, for example combining the architectures presented above within a hybrid architecture.

### Use Case

The methods proposed in the present disclosure may be used in the context of various use cases, for example such as the use case of determining the location of a stolen vehicle when the vehicle is equipped with a discoverable device (“discoverable node”) corresponding to the second device.

According to one particular exemplary implementation of this use case, let us envisage a first device used as a tracker and configured to operate in a LoRaWAN public network. As the LoRaWAN network is public, the first device is therefore configured to operate in the LoRaWAN network as a LoRaWAN end-device, and is furthermore associated with an end-device subscription to the LoRaWAN network.

The second device is a low-power device configured for the implementation of one or more embodiments of the methods proposed in the present disclosure, and may be carried on board a vehicle, preferably in a concealed manner, in order to allow locating the vehicle in the event of a theft.

In the case of a theft of the vehicle equipped with the second device, the vehicle may be taken to a place considered safe by the thieves, where the usual means for locating the vehicle will not be able to work (in particular not GPS). This may be a location where there is no WiFi coverage for example, and where determining the location by GPS is ineffective.

The second device (on board the stolen vehicle) may be configured to transmit, for example at regular intervals, and on one or more predefined frequency channels, a radio frequency signal carrying a wake-up message according to a predefined communication protocol between the first device and the second device.

The first device may also be carried on board a vehicle: a tracking vehicle which moves around in order to perform proximity detection of the second device. The first device may also be configured with a software application, for example called a tracking application, configured for the implementation of an embodiment of a proposed method for the first device. The tracking application may be activated on the first device when the use case of proximity detection is implemented.

When the first device is within an area of radio coverage of the radio frequency emissions of the second device, it is in a position to receive a wake-up message sent by the second device.

Receiving this wake-up message allows the first device (or a user of the first device) to determine that the presence of the second device has been detected in the vicinity, and to synchronize with the second device in order to exchange data with that device.

The first device may also only perform the processing of the received wake-up message which is aimed at synchronizing with the second device in order to exchange data with that device.

For example, the first device may transmit to the second device, for example on the one or more predefined frequency channels, a radio frequency signal carrying a receipt acknowledge message of the wake-up message, for example according to the predefined communication protocol between the first device and the second device.

The tracking application of the first device may be configured to emulate a relay node of the LoRaWAN network in relation to the second device, even though the second device is not an end-device of the LoRaWAN network and the first device is considered by the LoRaWAN network to be simply an end-device and not a LoRaWAN relay node. For example, the first device may be configured, upon receipt of a data packet from the second device, to relay this data packet by transmitting it to an application server in an uplink data transmission message according to a LoRaWAN network protocol.

Thus, the first device may be configured, by means of its tracking application, to relay data received from the second device to an application server connected to the LoRaWAN network, by encapsulating the data received in a data transmission message from a LoRaWAN end-device to the LoRaWAN network, for example in the payload of the data transmission message. A tunnel mechanism may thus be used to relay data received from the second device to the application server, by means of the LoRaWAN network.

The data received by the first device from the second device may comprise an identifier of the second device, for example a UUID type of universal identifier, which may then be relayed by the first device to the application server via a protocol message of the LoRaWAN network.

The application server may be configured to identify the second device or the vehicle on which it is mounted, on the basis of the data received from the second device, and to determine whether or not the vehicle is the subject of a search, for example following a theft.

The methods proposed in the present disclosure may advantageously be applied to the use case described above, and have the advantage of not requiring the second device to be a node of the LoRaWAN public network. A very large number of devices configured as second devices in the proposed methods may therefore be deployed, without incurring the additional cost of a subscription to the LoRaWAN network for each second device deployed.

### INDUSTRIAL APPLICATION

Depending on the embodiment chosen, certain acts, actions, events, or functions of each of the methods described herein may be performed or may occur in a different order than what has been described, or may be added, merged, or not performed or not occur, as the case may be. In addition, in certain embodiments, certain acts, actions, or events are performed or occur concurrently and not successively.

Although described using a certain number of detailed exemplary embodiments, the proposed control method and the device for implementing an embodiment of the method comprise various variants, modifications and improvements which will be obvious to those skilled in the art, it being understood that these various variants, modifications and improvements are within the scope of the present disclosure, as defined by the claims which follow. In addition, various aspects and features described above may be implemented together, or separately, or may be substituted for one another, and all the various combinations and sub-combinations of the aspects and features are within the scope of the present disclosure. Furthermore, some systems and devices described above may not incorporate all of the modules and functions described for the preferred embodiments.

1. A method of communication between a first device and a second device, the first device being a low-power wireless end-device of a LP-WAN type data communication network, and the second device being a low-power wireless device that is not a node of the LP-WAN type data communication network, the first device being configured to behave as a relay node with respect to the second device, the method being implemented by the first device and comprising:
receiving a wake-up message from the second device, via an application layer of the first device, on a frequency channel defined for wireless communications between the first device and the second device;
transmitting to the second device, via the application layer of the first device, a receipt acknowledge message of the wake-up message;
receiving a data packet from the second device, via the application layer of the first device; and
transferring, to an application server, via a node of the LP-WAN type data communication network, data from the data packet which are inserted in an uplink data transmission message in a communication protocol of the LP-WAN type data communication network.

2. A method of communication according to claim 1, further comprising:
transmitting, to the second device, a configuration command message comprising a command to switch to a transponder type of operating mode.

3. A method of communication according to claim 2, further comprising:
transmitting, to a location server configured to receive data from an LP-WAN type data communication network, data exchanged with the second device in radar mode.

4. A method of communication according to claim 1, further comprising:
listening in order to detect radio signals transmitted on one or more wake-up frequency channels during listening periods, detecting radio activity during a listening period among the listening periods, and switching to a reception mode in order to receive the wake-up message.

5. A method of communication according to claim 1, further comprising:
determining, via the application layer of the first device, whether the second device corresponds to one or more devices listed in a predefined list of devices.

6. A method of communication between a first device and a second device, the first device being a low-power wireless end-device of a LP-WAN type data communication network, and the second device being a low-power wireless device that is not a node of the LP-WAN type data communication network, the method being implemented by the second device, and comprising:
transmitting, to an application layer of the first device, a wake-up message on a frequency channel defined for wireless communications between the first device and the second device;
receiving, from the application layer of the first device, a receipt acknowledge message of the wake-up message; and
transmitting a data packet to the application layer of the first device.

7. A method according to claim 1, wherein the data communication network comprises a LoRaWAN type of network, the first device is an end-node of the LoRaWAN type of network which is configured to implement relay node functionalities of the LoRaWAN type of network via its application layer.

8. A method according to claim 7, wherein the wake-up message, the acknowledgment message, and the uplink data transmission message are messages in the LoRaWAN Relay protocol.

9. A wireless communication device comprising:
a radio transceiver;
a memory; and
at least one processor operably coupled to the radio transceiver and to the memory, and configured for the implementation of a method of communication between a first device and a second device, the first device being a low-power wireless end-device of a LP-WAN type data communication network, and the second device being a low-power wireless device that is not a node of the LP-WAN type data communication network, the first device being configured to behave as a relay node with respect to the second device, the method being implemented by the first device and comprising:
receiving a wake-up message from the second device, via an application layer of the first device, on a frequency channel defined for wireless communications between the first device and the second device;
transmitting to the second device, via the application layer of the first device, a receipt acknowledge message of the wake-up message;
receiving a data packet from the second device, via the application layer of the first device; and
transferring, to an application server, via a node of the LP-WAN type data communication network, data from the data packet which are inserted in an uplink data transmission message in a communication protocol of the LP-WAN type data communication network.

10. A non-transitory computer-readable medium encoded with executable instructions which, when executed, causes an apparatus comprising a processor operatively coupled with a memory, to perform a method of communication between a first device and a second device, the first device being a low-power wireless end-device of a LP-WAN type data communication network, and the second device being a low-power wireless device that is not a node of the LP-WAN type data communication network, the first device being configured to behave as a relay node with respect to the second device, the method being implemented by the first device and comprising:
receiving a wake-up message from the second device, via an application layer of the first device, on a frequency channel defined for wireless communications between the first device and the second device;
transmitting to the second device, via the application layer of the first device, a receipt acknowledge message of the wake-up message;
receiving a data packet from the second device, via the application layer of the first device; and
transferring, to an application server, via a node of the LP-WAN type data communication network, data from the data packet which are inserted in an uplink data transmission message in a communication protocol of the LP-WAN type data communication network.

11. A wireless communication device according to claim 9, wherein the method further comprises: transmitting, to the second device, a configuration command message comprising a command to switch to a transponder type of operating mode.

12. A wireless communication device according to claim 11, wherein the method further comprises: transmitting, to a location server configured to receive data from an LP-WAN type data communication network, data exchanged with the second device in radar mode.

13. A wireless communication device according to claim 9, wherein the method further comprises: listening in order to detect radio signals transmitted on one or more wake-up frequency channels during listening periods, detecting radio activity during a listening period among the listening periods, and switching to a reception mode in order to receive the wake-up message.

14. A wireless communication device according to claim 9, wherein the method further comprises: determining, via the application layer of the first device, whether the second device corresponds to one or more devices listed in a predefined list of devices.

15. A wireless communication device according to claim 9, wherein the data communication network comprises a LoRaWAN type of network, and the first device is an end-node of the LoRaWAN type of network which is configured to implement relay node functionalities of the LoRaWAN type of network via its application layer.

16. A wireless communication device according to claim 15, wherein the wake-up message, the acknowledgment message, and the uplink data transmission message are messages in the LoRaWAN Relay protocol.

17. A wireless communication device comprising:
a radio transceiver;
a memory; and
at least one processor operably coupled to the radio transceiver and to the memory, and configured for the implementation of a method of communication between a first device and a second device, the first device being a low-power wireless end-device of a LP-WAN type data communication network, and the second device being a low-power wireless device that is not a node of the LP-WAN type data communication network, the method being implemented by the second device, and comprising:
transmitting, to an application layer of the first device, a wake-up message on a frequency channel defined for wireless communications between the first device and the second device;
receiving, from the application layer of the first device, a receipt acknowledge message of the wake-up message; and
transmitting a data packet to the application layer of the first device.

18. A wireless communication device according to claim 17, wherein the data communication network comprises a LoRaWAN type of network, and the first device is an end-node of the LoRaWAN type of network which is configured to implement relay node functionalities of the LoRaWAN type of network via its application layer.

19. A wireless communication device according to claim 18, wherein the wake-up message, the acknowledgment message, and the uplink data transmission message are messages in the LoRaWAN Relay protocol.

20. A non-transitory computer-readable medium encoded with executable instructions which, when executed, causes an apparatus comprising a processor operatively coupled with a memory, to perform a method of communication between a first device and a second device, the first device being a low-power wireless end-device of a LP-WAN type data communication network, and the second device being a low-power wireless device that is not a node of the LP-WAN type data communication network, the method being implemented by the second device, and comprising:
transmitting, to an application layer of the first device, a wake-up message on a frequency channel defined for wireless communications between the first device and the second device;
receiving, from the application layer of the first device, a receipt acknowledge message of the wake-up message; and
transmitting a data packet to the application layer of the first device.
